(19) United States
(12) Patent Application Publication
(10) Pub. No.: US 2015/0128292 A1
(43) Pub. Date: May 7, 2015

(54) METHOD AND SYSTEM FOR DISPLAYING CONTENT INCLUDING SECURITY INFORMATION

(71) Applicant: Samsung Electronics Co., Ltd., Suwon-si (KR)

(72) Inventors: Mikolaj Michal MALECKI, Lomza (PL); Janusz Filip MAJNERT, Wielun (PL)

(21) Appl. No.: 14/529,657

(22) Filed: Oct. 31, 2014

(30) Foreign Application Priority Data
Nov. 1, 2013 (KR) 10-2013-0131957

(51) Int. Cl. G06F 21/62; G06F 21/31; G02B 27/01

(52) U.S. Cl. CPC G06F 21/6218; G02B 27/0172; G06F 21/31; G02B 2027/0178; G02B 2027/014; G02B 2027/0141
USPC 726/28; 726/26

(57) ABSTRACT

A method and a system for displaying content including security information by using a Virtual Reality (VR) technology are provided. A method for displaying content by an electronic device includes a see-through-type display apparatus and may include connecting a communication channel to another electronic device having a display unit, receiving security information from the other electronic device, and displaying the received security information through the see-through-type display apparatus.

### CROSS-REFERENCE TO RELATED APPLICATION(S)

This application claims the benefit under 35 U.S.C. §119(a) of Korean patent application filed on Nov. 1, 2013 in the Korean Intellectual Property Office and assigned Serial number 10-2013-0131957, the entire disclosure of which is hereby incorporated by reference.

### TECHNICAL FIELD

The present disclosure relates to a method and a system for displaying content including security information by using a Virtual Reality (VR) technology.

### BACKGROUND

Owing to the progress of information and communication technology, semiconductor technology and the like, the prevalence and use of various electronic devices have rapidly increased. For example, recently, there is a growing interest in a Head Mounted Display (HMD) device and technology related to the HMD device. An HMD device is a glasses-type HMD device mounted on the head of a user. The HMD devices can be classified into, for example, a closed-type HMD device with which the user cannot see the outside of the closed-type HMD device, and a see-through-type HMD device with which the user can collectively see an external environment and an image provided by a display.

The see-through-type HMD device uses a transparent display which enables the user to see the external environment, and thus can perform another task together. Accordingly, the see-through-type HMD device can be usually used as glasses, and can acquire information by connecting to an external device when the user desires to. For example, the see-through-type HMD device can be utilized to display information such as a notification message and the like, or to provide augmented reality. On the other hand, the closed-type HMD device has a structure in which the user cannot see an external environment, and thus enables the user to concentrate on an image provided by a display. The closed-type HMD device can output media contents, which are stored in a smart phone, a tablet Personal Computer (PC), a laptop computer and the like, on a large (e.g., more than 40 inches) virtual display, and thereby can increase a sense of reality. The closed-type HMD device can be utilized for the reproduction of multimedia in the case of movie appreciation. The closed-type HMD device can provide an environment in which the user feels as if the user looked at reality, in order to increase the sense of immersion.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an a method and a system for displaying content including security information, which can completely prevent the exposure of security information to other people by using a Virtual Reality (VR) technology.

Recently, there is a growing interest in security. However, electronic devices of the related art have display apparatuses exposed to the outside, and thus each have a danger of exposing security information displayed by the display apparatus to other people. In order to mitigate such a danger, the electronic device of the related art displays a password as a special character (e.g., an asterisk) when the password is input to the electronic device. However, the password may be inferred through a typing position and the like. Meanwhile, the closed-type Head Mounted Display (HMD) device may be used, but is problematic in that the user cannot see the outside of the closed-type HMD device.

Another aspect of the present disclosure is to provide a method and a system for displaying content including security information, which classify pieces of information into general information and security information when the content including the security information is displayed, display the general information through a first electronic device having a display unit exposed to the outside, and display the security information through a second electronic device having a display unit which is not exposed to the outside.

Another aspect of the present disclosure is to provide a method and a system for displaying content including security information, which overlap general information displayed by a first electronic device with security information displayed by a second electronic device and thereby allow the general information and the security information to look like one image.

In accordance with an aspect of the present disclosure, a method for displaying content by an electronic device is provided. The method includes a see-through-type display apparatus. The method may include connecting a communication channel to another electronic device having a display unit, receiving security information from the other electronic device, and displaying the received security information through the see-through-type display apparatus.

In accordance with another aspect of the present disclosure, a method for displaying content by an electronic device is provided. The method includes a display unit. The method may include requesting display of security content including security information and general information, extracting the security information from the security content, and displaying the general information through the display unit by the electronic device, and transmitting the extracted security information to another electronic device including a see-through-type display apparatus.

In accordance with another aspect of the present disclosure, a system for displaying content is provided. The system includes a first electronic device, comprising a display unit, configured to extract security information from security content and transmit the extracted security information when display of the security content comprising the security information and general information is requested, and to display the general information through the display unit, and a second electronic device, comprising a see-through-type display apparatus, configured to receive the security information from the first electronic device, and to display the received security information through the see-through-type display apparatus.

The method and the system for displaying content including security information, according to various embodiments of the present disclosure, provide security information in such a manner as not to be exposed to other people, and prevent other people from knowing even the fact that a user is identifying security information. Also, an electronic device (hereinafter referred to as a “second electronic device”) which displays security information by using a VR technology can display security information in the case of a user who is authenticated by using various authentication schemes (e.g., iris recognition, fingerprint recognition, voice recognition, the input of a password, etc.). Therefore, according to various embodiments of the present disclosure, security information can be securely protected even when the second electronic device is stolen.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description in conjunction with the accompanying drawings, in which:

FIG. 1 is a view illustrating a system for displaying content including security information according to an embodiment of the present disclosure;

FIGS. 2 and 3 are views illustrating a method for displaying content by a system according to an embodiment of the present disclosure;

FIG. 4 is a block diagram illustrating a configuration of a first electronic device according to an embodiment of the present disclosure;

FIG. 5 is a block diagram illustrating a configuration of a second electronic device according to an embodiment of the present disclosure;

FIG. 6 is a signal flow diagram illustrating a method for displaying content by a system according to an embodiment of the present disclosure;

FIG. 7 is a flowchart illustrating a method for displaying content by a first electronic device according to an embodiment of the present disclosure; and

FIG. 8 is a flowchart illustrating a method for displaying content by a second electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The various embodiments disclosed in the present specification and drawings were provided merely to readily describe and to help a thorough understanding of the present disclosure but not intended to limit the scope of the present disclosure. Therefore, it should be construed that all modifications or modified forms drawn by the technical idea of the present disclosure in addition to the various embodiments disclosed herein are included in the scope of the present disclosure.

Before the detailed description of the various embodiments of the present disclosure, security content described below signifies content including security information, which is not exposed to the outside, and general information exposed to the outside.

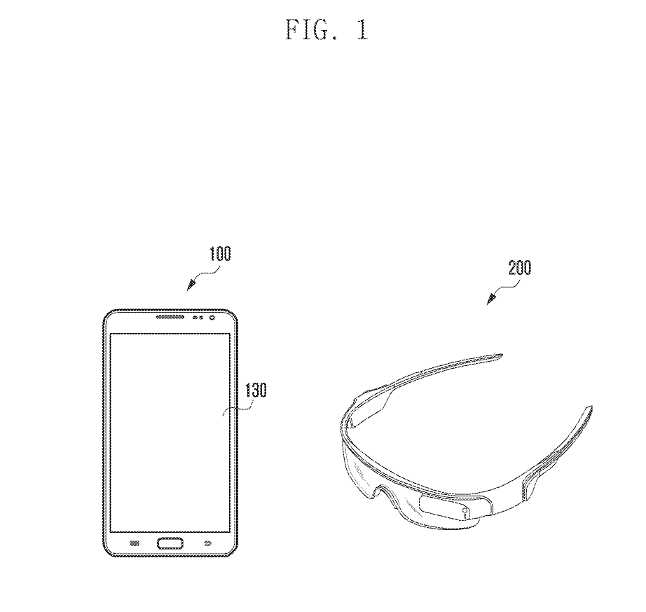

FIG. 1 is a view illustrating a system for displaying content including security information according to an embodiment of the present disclosure.

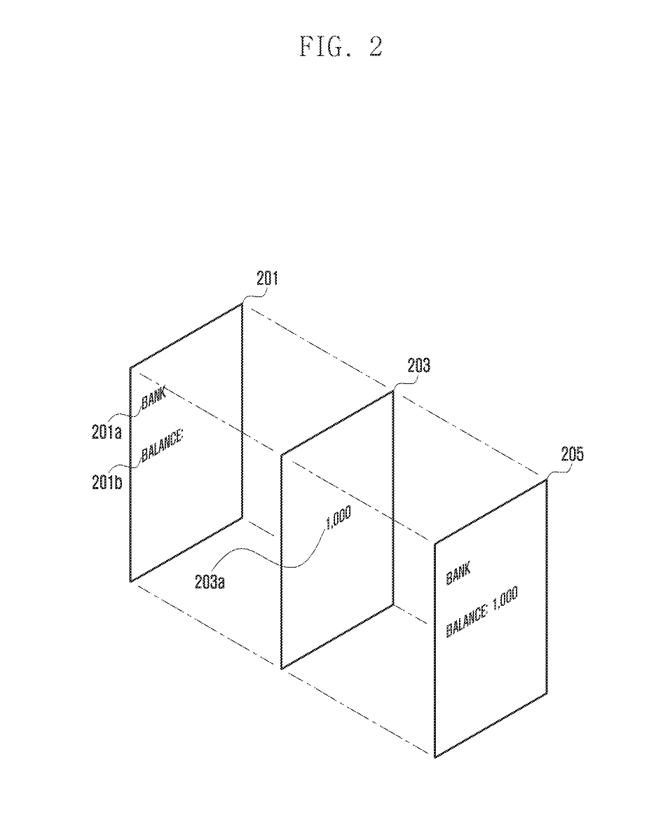

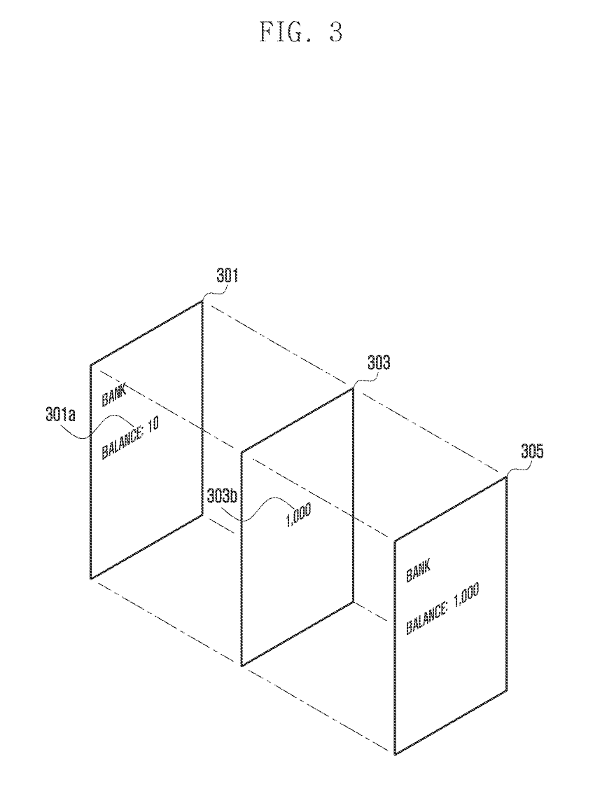

FIGS. 2 and 3 are views illustrating a method for displaying content by a system according to an embodiment of the present disclosure.

Referring to FIGS. 1 to 3, the system, according to an embodiment of the present disclosure, may include a first electronic device 100 and a second electronic device 200.

The first electronic device 100 is a terminal having a display apparatus. Examples of the first electronic device 100 may include a mobile communication terminal, a smart phone, a tablet Personal Computer (PC), a desktop PC, a laptop PC, an Internet Protocol Television (IPTV), a Personal Digital Assistant (PDA), a Portable Multimedia Player (PMP), a Moving Picture Experts Group Audio layer-3 (MP3) player, a video phone, an electronic book (e-book) reader, a mobile medical device, a camera, an Automatic Teller Machine (ATM), an electronic newspaper, a smart watch, and the like.

The second electronic device 200 may be a wearable device. The wearable device may include a see-through-type display apparatus which enables a user to see a displayed image and an external environment together. For example, the wearable device may be see-through-type Virtual Reality (VR) glasses. However, the second electronic device 200, according to an embodiment of the present disclosure, is not limited to the see-through-type VR glasses.

The second electronic device 200 may display an image in such a manner as not to be exposed to the outside (e.g., other people). In other words, an image which is output by the second electronic device 200 is not viewable to other people. When the second electronic device 200 is the see-through-type VR glasses, the second electronic device 200 may include a transparent (or translucent) lens, and may display content on a surface of the lens.

The second electronic device 200, according to an embodiment of the present disclosure, may connect a communication channel to the first electronic device 100. For example, the second electronic device 200 may connect a communication channel by wire or wirelessly to the first electronic device 100. The second electronic device 200 may connect a wired communication channel to the first electronic device 100 through a Universal Serial Bus (USB), a micro USB, a Universal Asynchronous Receiver Transmitter (UART), a display port, a mini display port, a High Definition Multimedia Interface (HDMI), and the like. Alternatively, the second electronic device 200 may connect a wireless communication channel to the first electronic device 100 according to Wi-Fi, Wi-Fi Direct, Bluetooth, Zigbee, and the like.

The first electronic device 100 may display content through a touch screen 130 thereof. The first electronic device 100, according to an embodiment of the present disclosure, may display security content. Specifically, when a request is made for displaying security content, the first electronic device 100 may display only general information included in security content through the touch screen 130 thereof. At this time, the first electronic device 100 may extract security information from the security content, and may transmit the extracted security information to the second electronic device 200.

The second electronic device 200 may receive the security information from the first electronic device 100, and may display the received security information. At this time, the user may recognize, as one image, the general information displayed by the first electronic device 100 and the security information displayed by the second electronic device 200. Specifically, the first electronic device 100 may display only the general information included in the security content on a screen thereof. For example, when a bank balance is identified, the first electronic device 100 may display a bank 201a and a balance 201b corresponding to words which are set as general information as indicated by reference numeral 201 in FIG. 2. The second electronic device 200 may display 1,000 203a representing balance information which is set as security information as indicated by reference numeral 203. At this time, the user may recognize, as one image, the general information and the security information because the general information and the security information overlap as indicated by reference numeral 205. In order to allow the general information and the security information to look like one image as described above, the second electronic device 200 may appropriately adjust a display position of 1,000 203a representing balance information in view of a distance between itself and the first electronic device 100, an eye-gaze direction of the user, a position of the head of the user, and the like.

As another example, the first electronic device 100 may display general information including fake balance information 301a as indicated by reference numeral 301 in FIG. 3. Actual balance information 303b may be displayed by the second electronic device 200 as indicated by reference numeral 303. At this time, the second electronic device 200 may overwrite the fake balance information 301a with the actual balance information 303b at a part where the fake balance information 301a is displayed. Accordingly, the user may view a screen image including the actual balance information 303b as indicated by reference numeral 305.

As described above, according to an embodiment of the present disclosure, general information and security information may be displayed by separate electronic devices. Specifically, the general information may be displayed by the first electronic device 100, and the security information may be displayed by the second electronic device 200. Accordingly, only the general information may be exposed to other people, but the security information may not be exposed to other people. Particularly, when the second electronic device 200 is in a form similar to that of glasses, other people cannot recognize that the user is seeing the security information through the second electronic device 200. In other words, the system according to an embodiment of the present disclosure may provide a steganography.

Meanwhile, a case has been described in which the second electronic device 200 receives and displays only the security information. However, various embodiments of the present disclosure are not limited thereto. For example, the second electronic device 200 may receive all pieces of information (e.g., general information and security information) included in content, and may filter only the security information from the content, and may display the security information. Alternatively, after receiving all the pieces of information included in the content, the second electronic device 200 may dimly display the general information, and may normally (or emphatically) display the security information.

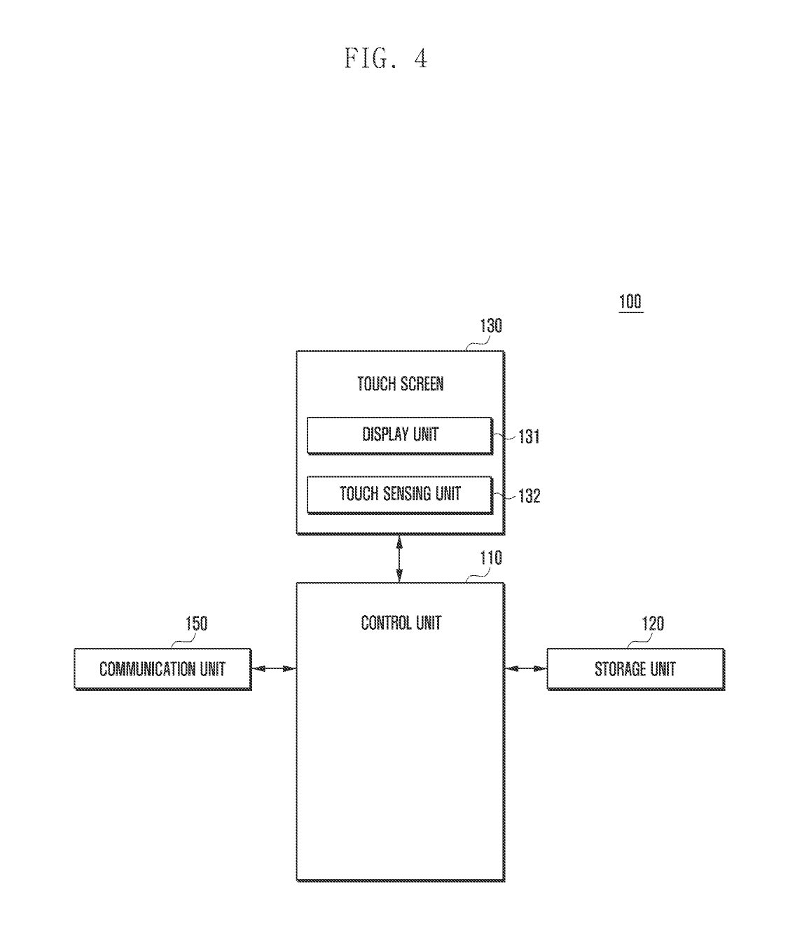

FIG. 4 is a block diagram illustrating a configuration of a first electronic device according to an embodiment of the present disclosure.

Referring to FIG. 4, according to an embodiment of the present disclosure, the first electronic device 100 may include a control unit 110, a storage unit 120, a touch screen 130, and a communication unit 150. The touch screen 130 may include a display unit 131 and a touch sensing unit 132.

The communication unit 150 may provide a communication function of the first electronic device 100. The communication unit 150 may connect a communication channel wirelessly or by wire to the second electronic device 200. For example, the communication unit 150 may include a mobile communication module, a Wireless Local Area Network (WLAN) module, a short-range communication module, and the like. The communication unit 150 may transmit and receive wireless signals to/from at least one of a base station, an external terminal, and various servers (e.g., an integration server, a provider server, a content server, etc.) through a mobile communication network. Examples of the wireless signal may include a voice call signal, video call signal, and data in various forms according to the transmission and reception of text/multimedia messages. Also, the communication unit 150 may provide wired communication functions using a USB, a micro USB, a UART, a display port, a HDMI, and the like.

The communication unit 150, according to an embodiment of the present disclosure, may transmit a communication channel connection request signal to the second electronic device 200. Also, the communication unit 150 may transmit security information included in security content to the second electronic device 200. Alternatively, the communication unit 150 may transmit the entire security content to the second electronic device 200.

The touch screen 130 may provide an output function and an input function. To this end, the touch screen 130 may include the display unit 131 and the touch sensing unit 132.

The display unit 131 may display information that the user has input, or information to be provided to the user, as well as various menus of the first electronic device 100. For example, the display unit 131 may provide various screens (e.g., a menu screen, a web page screen, a telephone call screen, etc.) according to the use of the first electronic device 100. The display unit 131, according to an embodiment of the present disclosure, may display general information included in security content. Alternatively, the display unit 131 may simultaneously display general information and fake security information. The display unit 131 may be implemented by a Liquid Crystal Display (LCD), an Organic Light Emitting Diode (OLED) display, an Active Matrix Organic Light Emitting Diode (AMOLED) display, and/or the like.

The touch sensing unit 132 is an apparatus for providing an input function. The touch sensing unit 132 may generate a touch event when a touch input means (e.g., a finger of the user, a stylus pen, an electronic pen, etc.) contacts or approaches the electronic device, and may provide the generated touch event to the control unit 110. Specifically, the touch sensing unit 132 may recognize the occurrence of a touch event based on a change in a physical quantity (e.g., capacitance, resistance, etc.) according to a contact or approach by the touch input means. The touch sensing unit 132, according to an embodiment of the present disclosure, may sense the input of a touch signal which controls a procedure for displaying security content. For example, the touch sensing unit 132 may sense a touch signal which requests the display of security content, a touch signal which requests the completion of the display of security content, and the like.

The storage unit 120 may store an Operating System (OS) of the first electronic device 100 and application programs required for other optional functions, such as a sound reproduction function, an image or moving image reproduction function, an Internet access function, a text message function, a map service function, and the like. Also, the storage unit 120 may store various data, such as moving image data, game data, music data, movie data, map data, and the like.

The storage unit 120, according to an embodiment of the present disclosure, may store a content display control program which controls the display of content including security information. The content display control program may include a command which controls the extraction of security information from security content, a command which controls the transmission of the extracted security information to the second electronic device 200, and a command which controls the display of general information on the display unit 131. Alternatively, the content display control program may instruct general information to be displayed together with fake security information when the general information is displayed. For example, when a balance at the bank is displayed, the content display control program may include a command which controls the display of not the actual balance but a preset fake balance.

The control unit 110 may control an overall operation of the first electronic device 100 and a signal flow between internal blocks of the first electronic device 100, and may perform a function of processing data. For example, the control unit 110 may include a Central Processing Unit (CPU), an Application Processor (AP), and the like. The control unit 110 may include, for example, a single-core processor, a multi-core processor, and/or the like.

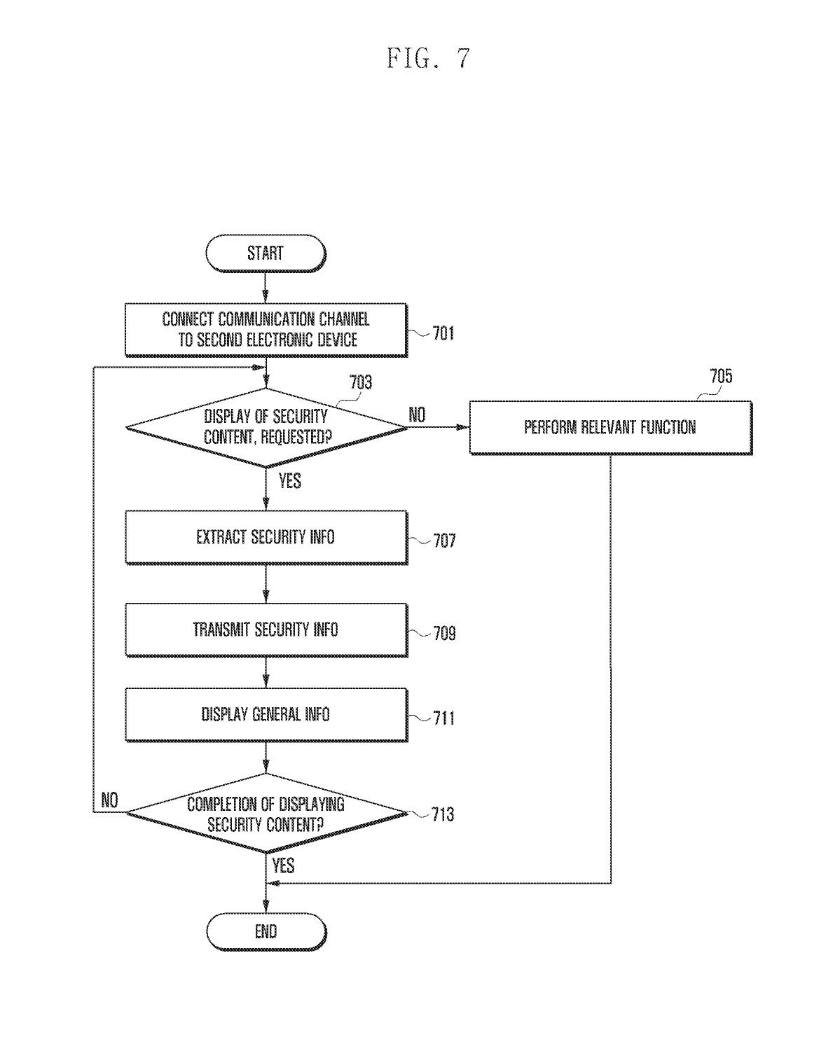

The control unit 110 may control the display of security content which is performed by operating in conjunction cooperation with the second electronic device 200. For example, the control unit 110 may extract security information from security content, and may transmit the extracted security information to the second electronic device 200. Also, the control unit 110 may control the display unit 131 to display only general information or to display the general information and fake security information together. For example, when a balance at the bank is displayed, the control unit 110 may instruct general information and a preset fake balance, which is not the actual balance, to be displayed. In this regard, a detailed description of the control unit 110 will be made further below with reference to FIG. 7.

Referring to FIG. 4, the first electronic device 100 may selectively include elements having additional functions, such as a broadcast reception module for receiving a broadcast signal, a sensor module including multiple sensors (e.g., a motion sensor, an illuminance sensor, an acceleration sensor, a geomagnetic sensor, etc.), a digital sound source reproduction module such as an MP3 module, and the like. In addition, the first electronic device 100 may further include elements equivalent to the above-described elements according to the convergence trend of digital devices.

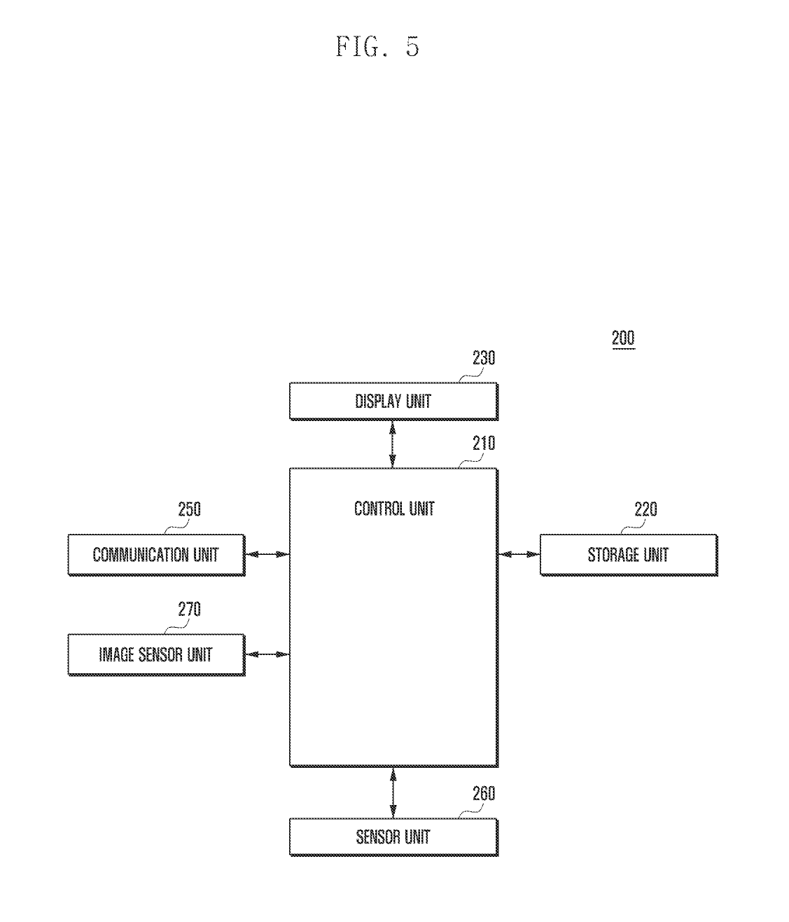

FIG. 5 is a block diagram illustrating a configuration of a second electronic device according to an embodiment of the present disclosure.

Referring to FIG. 5, according to an embodiment of the present disclosure, the second electronic device 200 may include a control unit 210, a storage unit 220, a display unit 230, a communication unit 250, a sensor unit 260, and an image sensor unit 270.

The image sensor unit 270 is an apparatus for capturing an image of a subject. For example, the image sensor unit 270 may convert the image obtained by capturing the subject into an electrical signal, and may store the electrical signal as digital data. The image sensor unit 270 may be implemented by a Charge-Coupled Device (CCD) image sensor, a Complementary Metal-Oxide Semiconductor (CMOS) image sensor, or the like. The image sensor unit 270 may be, for example, a camera module. The image sensor unit 270 may support a function of recognizing an eye-gaze direction of the user. For example, the second electronic device 200, according to an embodiment of the present disclosure, may acquire information on an eye-gaze direction of the user through the image sensor unit 270, and may provide the control unit 210 with the acquired information on the eye-gaze direction of the user. Also, when authentication is requested, the image sensor unit 270 may image-capture an eye (e.g., an iris) of the user, and may provide the image of the eye to the control unit 210.

The sensor unit 260 may include multiple sensors for measuring a distance, a direction, a motion, a wearing state, and the like. The sensor unit 260 may include an infrared sensor, a gravity sensor, a geomagnetic sensor, a motion sensor, an acceleration sensor, and the like. The sensor unit 260 may measure, for example, a distance between the second electronic device 200 and the first electronic device 100. Also, the sensor unit 260 may further include a fingerprint recognition sensor, a voice recognition sensor, an iris recognition sensor (in the case of the image sensor unit 270 which is not capable of iris recognition), and the like.

The communication unit 250 may receive security information from the first electronic device 100. Alternatively, the communication unit 250 may receive the entire security content including general information and security information. The communication unit 250 may receive a communication channel connection request signal or a communication channel connection release request signal. Here, the communication unit 250 provides functions similar to those of the communication unit 150 of the first electronic device 100, and thus a detailed description of the communication unit 250 will be omitted.

The display unit 230 may be a see-through-type display apparatus which enables the user to see the outside together with displaying an image. For example, when the second electronic device 200 is VR glasses, the display unit 230 may be a lens. The display unit 230 may display security information received from the first electronic device 100. Alternatively, the display unit 230 may display the entire security content. At this time, the display unit 230 may dimly display general information, and may display security information normally or emphatically. When an unauthenticated user wears the second electronic device 200, the display unit 230 may output an error message without displaying security information. Alternatively, the display unit 230 may output fake security information.

The storage unit 220 may store an OS of the second electronic device 200 and application programs required for other optional functions and the like. The storage unit 220 may store a position adjustment program which adjusts a display position of security information. The position adjustment program may measure a distance between the second electronic device 200 and the first electronic device 100, information on an eye-gaze direction of the user, and the like, and may control the display position of the security information. This configuration is for overlapping the general information displayed by the display unit 131 of the first electronic device 100 with the security information displayed by the display unit 230 of the second electronic device 200, and collectively displaying the general information and the security information to the user as if the user were viewing one image.

Also, the storage unit 220 may store authentication information for authenticating the user. The authentication information may be biometric information (e.g., iris information, fingerprint information, voice information, etc.). Alternatively, the authentication information may be an Identification (ID) and a password of the user.

The control unit 210 may control an overall operation of the second electronic device 200 and a signal flow between internal blocks of the second electronic device 200, and may perform a function of processing data. The control unit 210 may receive security information, and may display the received security information. At this time, the control unit 210 may measure a distance between the second electronic device 200 and the first electronic device 100, information on an eye-gaze direction of the user, and the like, and may control a display position of the security information, according to a result of the measurement.

When entire security content is received, the control unit 210 may filter general information from the entire security content, may dimly display the general information, and may normally (or emphatically) display security information.

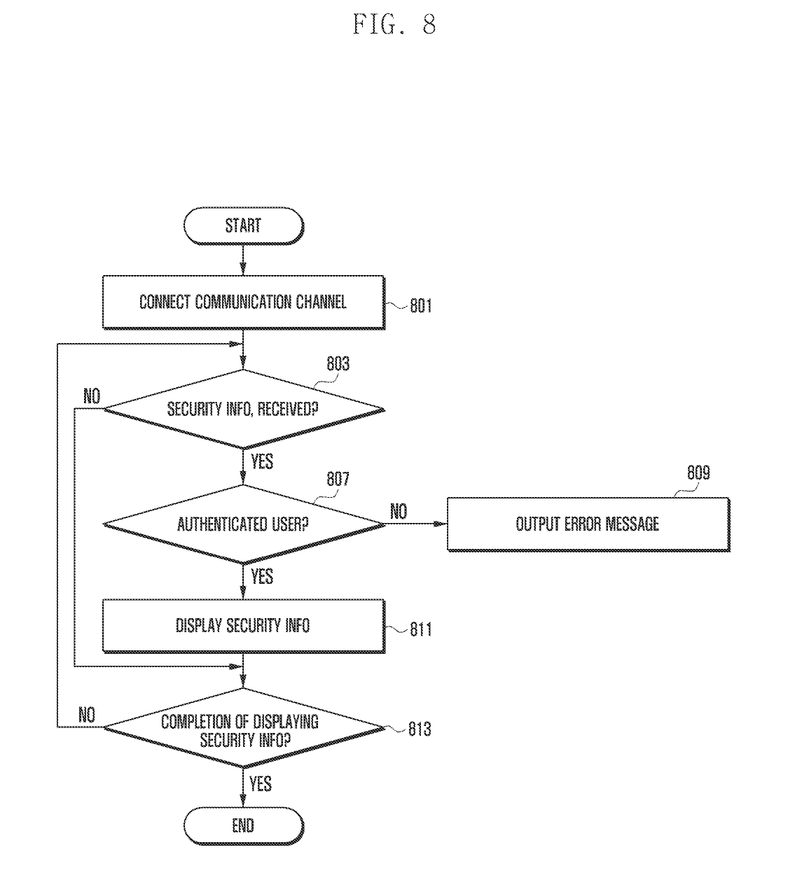

When wearing of the second electronic device 200 is sensed or a request for displaying security information is sensed, the control unit 210 may recognize an iris, a voice, a fingerprint or the like of a wearer, and may authenticate the user. Alternatively, the control unit 210 may authenticate the user by using identification information such as an ID and a password that the user inputs through an input apparatus. The first electronic device 100 may be the input apparatus. According to an embodiment of the present disclosure, the control unit 210 may authenticate the user by using a combination of the above-described methods or the corresponding method. In this regard, a detailed description of the control unit 210 will be made further below with reference to FIG. 8.

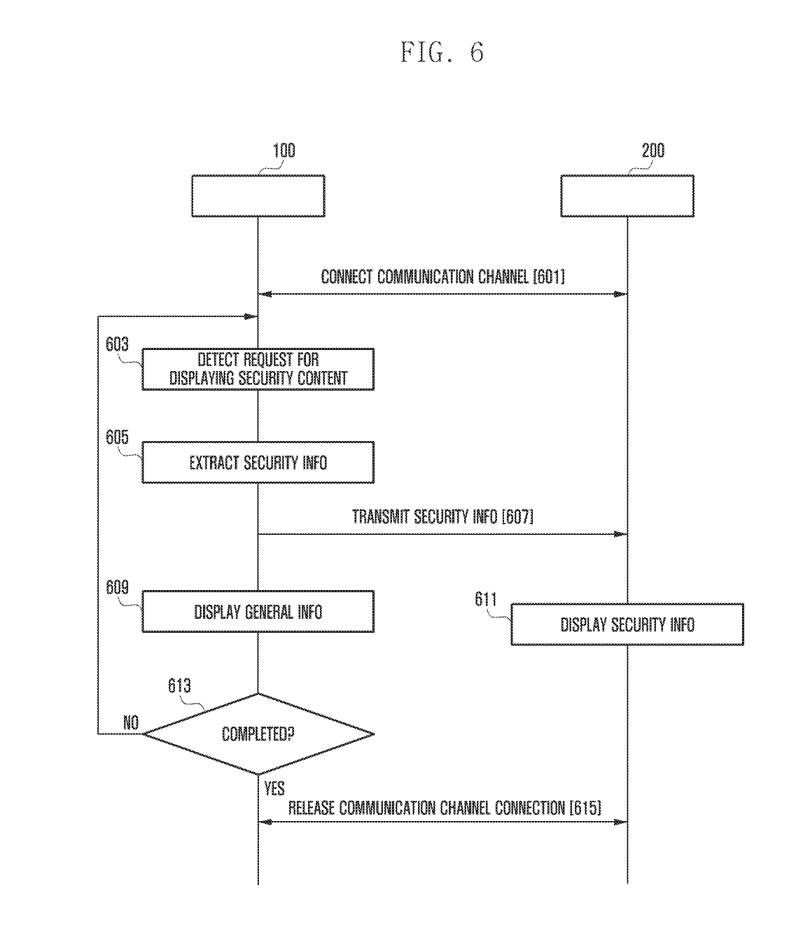

FIG. 6 is a signal flow diagram illustrating a method for displaying content by a system according to an embodiment of the present disclosure.

Referring to FIG. 6, in operation 601, the first electronic device 100 and the second electronic device 200, according to an embodiment of the present disclosure, may connect a communication channel therebetween. The first electronic device 100 and the second electronic device 200 may connect a communication channel by wire or wirelessly therebetween.

When the communication channel is connected between the first electronic device 100 and the second electronic device 200, in operation 603, the first electronic device 100 may detect a request for displaying security content. The security content is content including security information which is desired not to be exposed to the outside (i.e., viewable by other people). For example, when the first electronic device 100 is an ATM, the security information may be a password, balance information, and the like.

Alternatively, when the first electronic device 100 is a smart phone, a laptop computer, etc. and displays a web page, general information may be information for constructing a conventional web page which is open to the public, and security information may be a virtual keypad for inputting a password and a password input field. Because the password input field and the keyboard are displayed by the second electronic device 200 as described above, the second electronic device 200 does not display the password by using a special character (e.g., an asterisk) as in the past, but may display the password by using numbers or characters. In various embodiments of the present disclosure, the user can be prevented from incorrectly inputting the password. Alternatively, when a touch occurs on the touch screen of the first electronic device 100, a part covered by fingers of the user is displayed by the second electronic device 200, so that the usability of the first electronic device 100 can be improved.

In operation 605, the first electronic device 100 may extract security information from security content. When the extraction of security information is completed, in operation 607, the first electronic device 100 transmits the extracted security information to the second electronic device 200. In operation 609, the first electronic device 100 may display general information through the display unit 131. When receiving the security information, in operation 611, the second electronic device 200 may display the security information through the display unit 230. At this time, the second electronic device 200 may appropriately adjust an output position of the security information in view of a distance between itself and the first electronic device 100, an eye-gaze direction of the user, a position of the head of the user, and the like. For example, as described above with reference to FIG. 2 and FIG. 3, the second electronic device 200 may adjust a display position of the security information in such a manner that the general information displayed by the first electronic device 100 and the security information displayed by the second electronic device 200 overlap each other and can be collectively recognized as one image.

In operation 613, the first electronic device 100 may determine whether the completion of displaying the security content is requested. When the completion of displaying the security content is not requested, the first electronic device 100 may return to operation 603. In contrast, when the completion of displaying the security content is requested, in operation 615, the first electronic device 100 may release the communication channel connection.

Referring to FIG. 6, when the second electronic device 200 receives security information, the second electronic device 200 may authenticate a user. For example, the second electronic device 200 may determine whether the user is an authenticated user by using iris recognition, fingerprint recognition, the input of a password, voice recognition, and the like. The iris recognition, fingerprint recognition, the input of a password, voice recognition, and the like may occur and at least one of the first electronic device 100, the second electronic device 200, and one or more other electronic devices. Only when the user is an authenticated user, the second electronic device 200 may output security information. Meanwhile, the second electronic device 200, according to another embodiment of the present disclosure, may authenticate a user when the second electronic device 200 detects use (e.g., wearing) by the user.

Meanwhile, hereinabove, a case has been described in which the display of security content is requested in a state where a communication channel is connected between the first electronic device 100 and the second electronic device 200. However, various embodiments of the present disclosure are not limited thereto. For example, in another embodiment of the present disclosure, when the display of security content is requested, the first electronic device 100 may connect a communication channel to the second electronic device 200. Also, it has been illustrated that the first electronic device 100 extracts security information and transmits the extracted security information to the second electronic device 200 before displaying general information. However, the first electronic device 100, according to another embodiment of the present disclosure, may extract security information and may transmit the extracted security information to the second electronic device 200, after displaying general information.

Also, it has been illustrated that the first electronic device 100 releases a communication channel connection. However, in another embodiment of the present disclosure, the second electronic device 200 may release a communication channel connection.

FIG. 7 is a flowchart illustrating a method for displaying content by a first electronic device according to an embodiment of the present disclosure.

Referring to FIG. 7, in operation 701, the control unit 110 of the first electronic device 100, according to an embodiment of the present disclosure, may search for a particular electronic device (hereinafter, the second electronic device 200), and may connect a communication channel to the second electronic device 200.

In operation 703, the control unit 110 may determine whether the display of security content is requested. When the display of security content is not requested, in operation 705, the control unit 110 may perform a relevant function. For example, the control unit 110 may perform a function, such as a music reproduction function, an Internet access function, a camera function, and the like, or may maintain a standby state.

In contrast, when the display of security content is requested, the control unit 110 proceeds to operation 707, and may extract security information from security content. In operation 709, the control unit 110 may transmit the extracted security information to the second electronic device 200. In operation 711, the control unit 110 may display general information through the display unit 131.

In operation 713, the control unit 110 may determine whether the completion of displaying the security content is requested. When the completion of displaying the security content is not requested, the control unit 110 returns to operation 703, and may repeatedly perform the above-described process. In contrast, when the completion of displaying the security content is requested, the control unit 110 may complete a content display procedure.

FIG. 8 is a flowchart illustrating a method for displaying content by a second electronic device according to an embodiment of the present disclosure.

Referring to FIG. 8, in operation 801, the control unit 210 of the second electronic device 200, according to an embodiment of the present disclosure, may connect a communication channel to a particular electronic device (hereinafter, the first electronic device 100).

In operation 803, the control unit 210 may determine whether security information is received from the first electronic device 100. When the security information is not received, the control unit 210 may proceed to operation 813 described below. In contrast, when the security information is received, the control unit 210 proceeds to operation 807, and may determine whether the user is an authenticated user. The control unit 210 may determine whether the user is an authenticated user, in various authentication schemes, such as iris recognition, voice recognition, fingerprint recognition, the input of a password, and the like.

In operation 807, when the user is not an authenticated user, the control unit 210 proceeds to operation 809, and may output an error message. Meanwhile, in another embodiment of the present disclosure, when the user is not an authenticated user, the control unit 210 of the second electronic device 200 may perform a control operation for outputting general information without outputting an error message. In this configuration, when the second electronic device 200 is stolen, other people recognize that the second electronic device 200 is not a device providing a special function such as a function of outputting security content but is a device providing only a typical function.

When the user is an authenticated user in operation 807, the control unit 210 proceeds to operation 811, and may display the security information through the display unit 230. At this time, the control unit 210 may adjust a display position of the security information based on eye-gaze direction information and a distance between the second electronic device 200 and the first electronic device 100.

In operation 813, the control unit 210 may determine whether the completion of displaying the security information is requested. When the completion of displaying the security information is not requested, the control unit 210 may return to operation 803. In contrast, when the completion of displaying the security information is requested, the control unit 210 may complete a content display procedure.

The content displaying method according to various embodiments of the present disclosure, as described above, may be implemented in a form of a program command which can be executed through various computer means and may be recorded in a non-transitory computer-readable recording medium. The non-transitory computer-readable recording medium may include, alone or in combination, a program command, a data file, a data structure, and the like. The program command recorded in the medium is specially designed and configured for the present disclosure, but may be used after being known to those skilled in computer software fields. The non-transitory computer-readable recording medium includes magnetic media such as hard disks, floppy disks and magnetic tapes, optical media such as a Compact Disc Read-Only Memory (CD-ROM) and a Digital Versatile Disc (DVD), magneto-optical media such as floptical disks, and hardware devices such as a Read-Only Memory (ROM), a Random Access Memory (RAM) and a flash memory, which are specially configured to store and perform program commands. Further, the program command includes a machine language code generated by a compiler and a high-level language code executable by a computer through an interpreter and the like. The hardware devices may be configured to operate as one or more software modules to perform the operations of the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for displaying content by an electronic device comprising a see-through-type display apparatus, the method comprising:
connecting a communication channel to another electronic device having a display unit;
receiving security information from the other electronic device; and
displaying the received security information through the see-through-type display apparatus.

2. The method of claim 1, wherein the displaying of the received security information comprises:
determining whether a user is an authenticated user; and
displaying the received security information when the user is the authenticated user.

3. The method of claim 2, wherein the determining of whether the user is the authenticated user includes at least one of iris recognition, voice recognition, fingerprint recognition, and input of a password.

4. The method of claim 2, further comprising outputting an error message when the user is not the authenticated user.

5. The method of claim 2, further comprising outputting general information when the user is not the authenticated user.

6. The method of claim 1, wherein the receiving of the security information comprises receiving the security information and general information from the other electronic device, and
wherein the displaying of the received security information comprises displaying the received general information more dimly than other displayed information.

7. The method of claim 1, comprising:
measuring a distance between the electronic device and the other electronic device and information on an eye-gaze direction of a user; and
adjusting a display position of the security information based on a result of the measurement.

8. A non-transitory computer-readable recording medium having stored thereon program commands, which when executed by a computer, performs the method of claim 1.

9. A method for displaying content by an electronic device comprising a display unit, the method comprising:
requesting display of security content comprising security information and general information;
extracting the security information from the security content; and
displaying the general information through the display unit by the electronic device, and transmitting the extracted security information to another electronic device comprising a see-through-type display apparatus.

10. The method of claim 9, wherein the displaying of the general information through the display unit by the electronic device comprises collectively displaying the general information and fake security information.

11. A non-transitory computer-readable recording medium having stored thereon program commands, which when executed by a computer, performs the method of claim 9.

12. A system for displaying content, the system comprising:
a first electronic device, comprising a display unit, configured to extract security information from security content and transmit the extracted security information when display of the security content comprising the security information and general information is requested, and to display the general information through the display unit; and
a second electronic device, comprising a see-through-type display apparatus, configured to receive the security information from the first electronic device, and to display the received security information through the see-through-type display apparatus.

13. The system of claim 12, wherein the first electronic device collectively displays the general information with fake security information, when displaying the general information.

14. The system of claim 12, wherein the second electronic device determines whether a user is an authenticated user, and displays the security information through the see-through-type display apparatus, when the user is the authenticated user.

15. The system of claim 14, wherein the second electronic device outputs an error message when the user is not the authenticated user.

16. The system of claim 14, wherein the second electronic device outputs the general information when the user is not the authenticated user.

17. The system of claim 12, wherein the second electronic device receives the security information with the general information when receiving the security information from the first electronic device, and displays the received general information more dimly than other displayed information.

18. The system of claim 12, wherein the general information displayed by the first electronic device and the security information displayed by the second electronic device overlap each other, and form one image.

19. The system of claim 12, wherein the second electronic device measures a distance between the second electronic device and the first electronic device and information on an eye-gaze direction of a user, and adjusts a display position of the security information based on a result of the measurement.

20. The system of claim 12, wherein the second electronic device comprises a Head Mounted Display (HMD).
